(19) United States
(12) Patent Application Publication
(10) Pub. No.: US 2020/0108929 A1
(43) Pub. Date: Apr. 9, 2020

(54) UNMANNED AERIAL VEHICLE AND METHOD FOR ASSEMBLING UNMANNED AERIAL VEHICLE

(71) Applicant: SZ DJI TECHNOLOGY CO., LTD., Shenzhen (CN)

(72) Inventors: Jiangang FENG, Shenzhen (CN); Yin TANG, Shenzhen (CN)

(21) Appl. No.: 16/704,531

(22) Filed: Dec. 5, 2019

Related U.S. Application Data
(63) Continuation of application No. PCT/CN2017/091104, filed on Jun. 30, 2017.

(51) Int. Cl. B64C 39/02; B64C 25/04; B64C 25/06; B64D 47/00; G01C 9/00; G01P 15/18; G01L 19/14

(52) U.S. Cl. CPC B64C 39/024; B64C 25/04; B64C 25/06; G01L 19/147; G01C 9/005; G01P 15/18; B64D 47/00

(57) ABSTRACT

An unmanned aerial vehicle (“UAV”) includes an aircraft body and a rotor assembly mounted on the aircraft body. The UAV also includes a barometer disposed external to the aircraft body and separated from the rotor assembly at a predetermined distance.

### CROSS-REFERENCE TO RELATED APPLICATION

This application is a continuation application of International Application No. PCT/CN2017/091104, filed on Jun. 30, 2017, the entire content of which is incorporated herein by reference.

### TECHNICAL FIELD

The present disclosure relates to an unmanned aerial vehicle (“UAV”) and a method for assembling the UAV.

### BACKGROUND

Because UAVs have features such as a small volume and a flexible maneuverability, they have been widely implemented in various technical fields.

In actual use, the height measurement of the UAV is usually performed through a barometer, by measuring the air pressure information at the height where the UAV is located to determine the height of the UAV. In current technical solutions, the barometer is typically disposed inside the aircraft body. Because in a flight of the UAV, the rotation of the propellers can cause turbulence in the air flow inside the aircraft body, such situation may seriously affect the accuracy of the data measurement of the barometer. In accuracy in the data measurement of the barometer can cause instability issues such as fixed height, losing height, drifting height.

### SUMMARY

In accordance with an aspect of the present disclosure, there is provided an unmanned aerial vehicle (“UAV”) that includes an aircraft body and a rotor assembly mounted on the aircraft body. The UAV also includes a barometer disposed external to the aircraft body and separated from the rotor assembly at a predetermined distance.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is a schematic illustration of a partial assembly of the UAV, according to an example embodiment.

FIG. 2 is an exploded view of an extension member of the UAV shown in FIG. 1, according to an example embodiment.

FIG. 3 is a schematic illustration of an assembly of the extension member shown in FIG. 2, according to an example embodiment.

FIG. 4 is a schematic illustration of an electrical connection in the UAV shown in FIG. 1, according to an example embodiment.

FIG. 5 is a flow chart illustrating a method of assembling the UAV shown in FIG. 1, according to an example embodiment.

Description of Major Element Label

| | |
|---|---|
| UAV | 100 |
| Aircraft body | 10 |
| Extension member | 30 |
| Connection member | 31 |
| Connection member main body | 311 |
| Mounting member | 3111 |
| Connection member cover | 312 |
| Supporting member | 32 |
| Supporting member main body | 321 |
| Supporting member cover | 322 |
| Receiving member | 33 |
| First receiving member | 331 |
| Second receiving member | 332 |
| Air port | 333 |
| Barometer | 40 |
| Air filter | 50 |
| Inertial measurement unit | 60 |
| Flight controller | 70 |
| Electronic speed control | 80 |

The following embodiments will be described with reference to the accompanying drawings.

### DETAILED DESCRIPTION OF THE EMBODIMENTS

Technical solutions of the present disclosure will be described in detail with reference to the drawings, in which the same numbers refer to the same or similar elements unless otherwise specified. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

It should be understood, when an element is described as being “fixed to” another element, it can be directly fixed to the other element, or there may be an intermediate element between them. When an element is described as being “connected” with another element, it may be directly connected with the other element or there may be an intermediate element between them. When an element is described as being “disposed” at another element, it may be directly disposed at the other element or there may be an intermediate element between them.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

In the process of implementing the technical solution of the present disclosure, the inventors discovered the following issues:

In the conventional technical solutions of the UAV, a barometer is typically disposed inside the aircraft body. Because in a flight of the UAV, the rotation of the propellers can cause turbulence in the air flow inside the aircraft body, such a situation may seriously affect the operation accuracy of the data measurement of the barometer. The low operation accuracy of the barometer may cause the UAV to have instability issues, such as fixed height, losing height, and drifting height. The current method to address the issues is to find a location where the air flow is in a relative equilibrium inside the aircraft body of the UAV. The inventors made key improvements in the mounting location of the barometer and in reducing the effect of the air flow as much as possible.

The barometer of the present disclosure is disposed on an extension member that is connected to the aircraft body of the UAV, and is separated from the propellers for a predetermined distance, to reduce the effect of the air flow generated by the rotation of the propellers on the barometer. Next, through the detailed embodiments, the configuration of the UAV having the barometer disposed external to the aircraft body will be described.

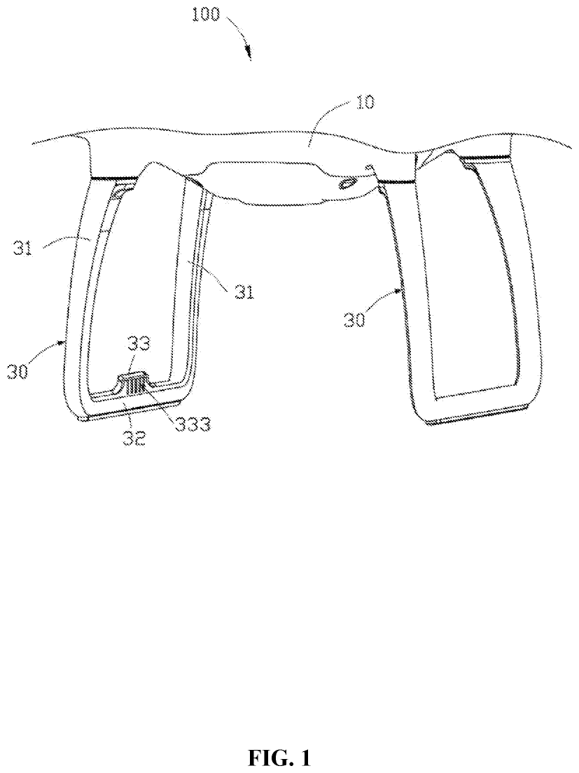

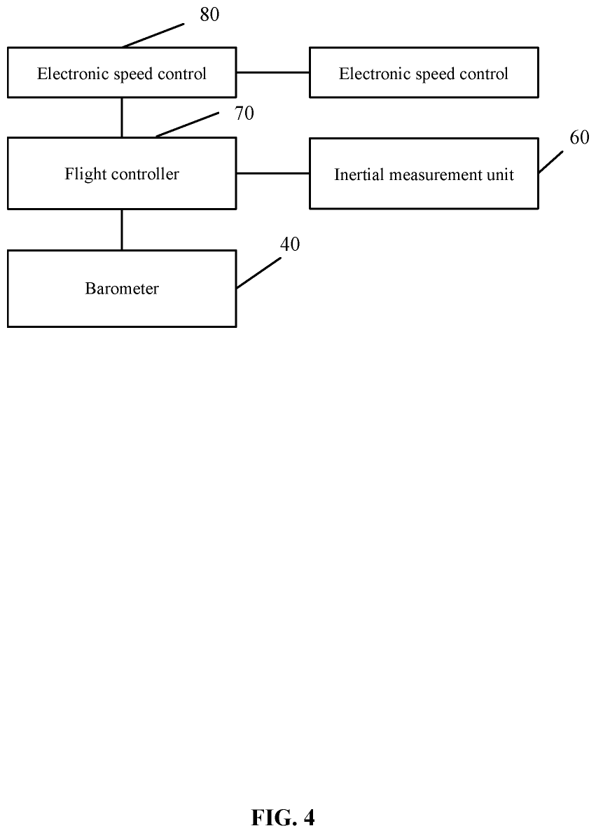

Referring to both FIG. 1 and FIG. 4, in which, FIG. 1 is a schematic illustration of a partial assembly of the UAV, and FIG. 4 is a schematic illustration of the electrical connection of the UAV shown in FIG. 1. A UAV 100 may include an aircraft body 10, a rotor assembly (not shown), an extension member 30, a barometer 40, an air filter 50, an inertial measurement unit (“IMU”) 60, a flight controller 70, and an electronic speed control 80. The rotor assembly may be disposed at a top portion of the aircraft body 10. The extension member 30 may be disposed at a bottom portion of the aircraft body 10. The barometer 40 may be disposed in the extension member 30. The electronic speed control 80 and the IMU 60 may be disposed inside the aircraft body 10, and both may be electrically connected with the flight controller 70.

The aircraft body 10 may be the main part of the UAV 100. The aircraft body 10 may include a receiving space configured to receive the majority of electronic elements of the UAV 100.

The rotor assembly may include electric motors (not shown) and propellers (not shown) coupled with the electric motors. The electric motors may be configured to drive the propellers to rotate. The electric motors and the electronic speed control 80 may be electrically connected. The operation state of the electric motors may be controlled by the electronic speed control 80. The propellers may be straight propellers or foldable propellers, which are not limited by the present disclosure.

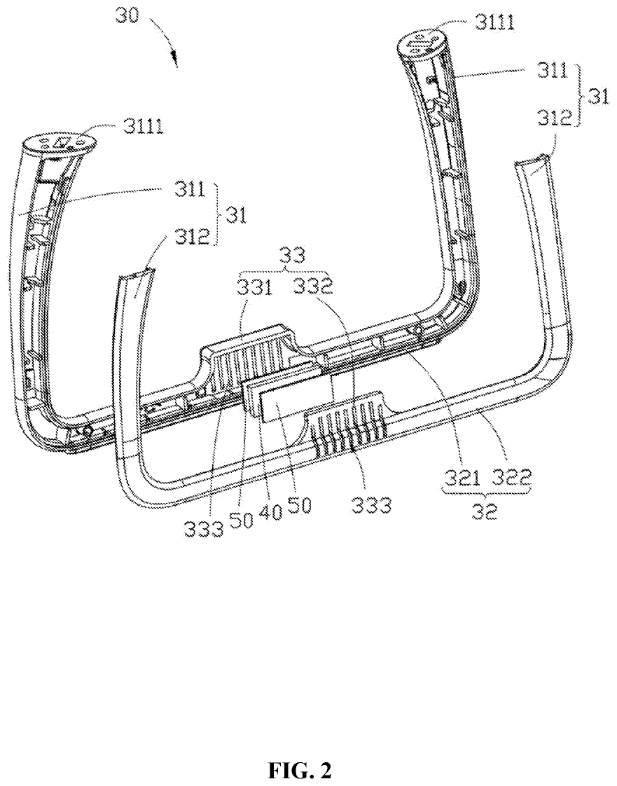

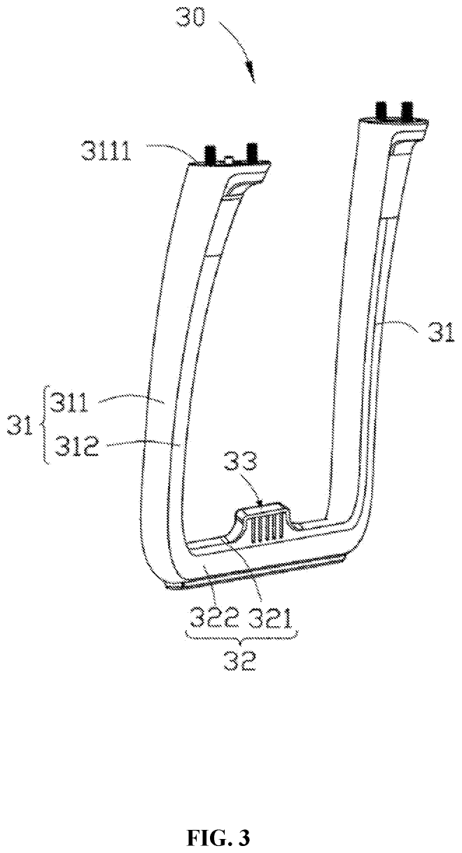

Referring to FIG. 2 and FIG. 3, the extension member 30 may be connected with the aircraft body 10. Specifically, the extension member 30 may be disposed at the bottom portion of the aircraft body 10 and may extend in a direction away from the aircraft body 10. In other words, an end of the extension member 30 may be connected with the aircraft body 10, the other end may extend in the direction away from the rotor assembly. The extension member 30 and the rotor assembly may be respectively disposed at the bottom and the top portions of the aircraft body 10. In some embodiments, two extension members 30 may be included. An end of each of the two extension members 30 may be connected with the aircraft body 10, the other end of each of the two extension members 30 may extend in the direction away from the rotor assembly. In addition, the extension member 30 of the present disclosure is the landing stand of the UAV 100. The landing stand may be configured to provide support of the UAV 100 when landing or when parked.

The extension member 30 may include a connection member 31 and a supporting member 32. The connection member 31 and the supporting member 32 may be connected.

An end of the connection member 31 may be connected with a bottom portion of the aircraft body 10, i.e., connected with a side against the rotor assembly, the other end may extend in the direction away from the rotor assembly. The connection member 31 may include a connection member main body 311 and a connection member cover 312. The connection member cover 312 may cover the connection member main body 311, and may assemble with the connection member main body 311 to form the connection member 31.

The connection member main body 311 may include a receiving space. The receiving space may receive electronic elements, such as the barometer, etc. An end of the connection member main body 311 may be connected with the aircraft body 10, the other end may be connected with the supporting member 32. The end of the connection main body 311 may include a mounting member 3111. The mounting member 3111 may be connected with the aircraft body 10. The mounting member 3111 may be connected with the aircraft body 10 using rivet connections, snap-fit connections, glue connections, etc.

The connection member cover 312 may cover the connection member main body 311, and may assemble with the connection member main body 311 to form the connection member 31 having the receiving space.

In the present disclosure, there may be two connection members 31. That is, each extension member 30 may include two connection members 31. The two connection members 31 may have the same structure, and may be separately disposed at a predetermined distance. An end of the two connection members 31 away from the rotor assembly may connect with two ends of the supporting member 32, respectively.

The supporting member 32 may be connected with an end of the connection member 31 away from the rotor assembly. Specifically, the two ends of the supporting member 32 may connect with ends of the two connection members 31 away from the rotor assembly, respectively. In addition, the middle portion of the supporting member 32 may form a receiving member 33 having a receiving space. It may be understood that in other embodiments, the number of the connection member 31 may be one. In such an embodiment, the supporting member 32 may also be connected with an end of the connection member 31 away from the rotor assembly. The present disclosure does not limit the number of the connection members 31.

The supporting member 32 may include a supporting member main body 321 and a supporting member cover 322. The supporting member main body 321 and the supporting member cover 322 may assemble and connect together to form the supporting member 32.

The supporting member main body 321 may be fixed with the supporting member cover 322 through rivet connections, snap-fit connections, and glue connections. Two ends of the supporting member main body 321 may be connected with an end of each of the two connection member main bodies 311 away from the rotor assembly, respectively. In this embodiment, the supporting member main body 321 and the two connection member main bodies 311 may be an integrally formed structure.

The two ends of the supporting member cover 322 may be connected with an end of each of the two connection member covers 312 away from the rotor assembly, respectively. in some embodiments, the supporting member cover 322 and the two connection member covers 312 may be an integrally formed structure. It can be understood that the connection member covers 312 may be omitted. The barometer 40 may be sealed through the supporting member cover 322.

The receiving member 33 may be formed at the middle portion of the supporting member 32 of one of the extension members 30. The receiving member 33 may be configured to receive the barometer 40. It can be understood that the receiving member 33 may be located at a farthest location on the extension member 30 away from the rotor assembly. The receiving member 33 may include a first receiving member 331 and a second receiving member 332. The first receiving member 331 and the second receiving member 332 may assembly together to form the receiving member 33. The receiving member 33 may include an air port 333, such that the interior of the receiving member 33 is connected with the external environment, thereby rendering it convenient for the barometer 40 disposed therein to measure the external air pressure information.

The first receiving member 331 may be formed at the middle portion of the supporting member main body 321. The first receiving member 331 may be provided with an air port 333. The number of the air port may be multiple. In some embodiments, the first receiving member 331 and the supporting member main body 321 may be an integrally formed structure. In some embodiments, the air port 333 may include multiple strip-shaped grooves that are disposed in an array. It can be understood that the air port may include multiple structures, such as multiple separately disposed strip-shaped groove, or multiple holes separately disposed or disposed in an array.

The second receiving member 332 may be formed at the middle portion of the supporting member cover 322, and may be disposed corresponding to the location of the first receiving member 331 at the supporting member main body 321. Specifically, the second receiving member 332 and the first receiving member 321 may be opposingly disposed. The two may correspondingly assembly and connect together to form the receiving member 33. The second receiving member 332 may similarly have an air port 333. The air port 333 of the second receiving member 332 may be opposingly disposed with respect to the air port 333 of the first receiving member 331. The second receiving member 332 and the supporting member cover 322 may be an integrally formed structure.

In an embodiment, the number of the barometer 40 may be one. The barometer 40 may be disposed inside the receiving member 33. The barometer 40 may be wrapped by the air filter 50. In another embodiment, the number of the barometer 40 may be two. Correspondingly, the number of the extension member 30 may also be two. One of the barometers 40 may be similarly disposed inside the receiving member 33, and is surrounded at an outer side by the air filter 50. Another one of the barometers 40 may be disposed in one of the connection members 31 of the extension member 30 that does not include the receiving member 33. Specifically, the other barometer 40 may be disposed inside the receiving space of the connection member 31. It can be understood that an outer side of the other barometer 40 may also be surrounded by the air filter.

The barometer 40 may be configured to detect the air pressure data at the location where the barometer 40 is located, and may transmit the detected data to the flight controller 70. It can be understood that in another embodiment of the present disclosure, the number of barometers 40 may be two. The two barometers 40 may have the same distance to the rotor assembly, or may have different distances to the rotor assembly. The distance may be a perpendicular distance along the central axis line of the UAV 100. Specifically, the heights of the two barometers 40 may be the same or different. For example, the two barometers 40 may be disposed respectively at the same locations inside the supporting member 32 of the two extension member 30, and air ports 333 may be provided at the same portions. Alternatively, the two barometers 40 and the air ports 333 may be disposed at different portions of the two supporting member 32.

Specifically, the barometers 40 and the air ports 333 may be disposed in the two supporting members 32 as shown in FIG. 2. The two receiving members 33 may both extend to the lower edge of the supporting member 32. The barometer 40 may be received in the receiving member 33, and the air port 333 may extend to the lower edge of the supporting member 32. In this configuration, the two barometers 40 have the same heights and the same distances to the rotor assembly at the corresponding sides. Alternatively, the two barometers 40 and the air ports 333 may be provided in the two supporting members 32 as shown in FIG. 3. The receiving members 33 on the two supporting members 32 may both be provided above the supporting members 32. The air ports 333 may extend to the upper edge of the supporting members 32. In this embodiment, the two barometers 40 may be symmetrically disposed at a middle location of the supporting member 32, or may be asymmetrically disposed on the supporting member 32, where the heights of the two may be the same. In addition, the two barometers 40 may be disposed at a location on the connection member 31 far away from the aircraft body 10, where the heights of the two are the same.

In addition, at one supporting member 32, the barometer 40 and the air port 333 may be disposed as shown in FIG. 2, and at the other supporting member 32, the barometer 40 and the air port 333 may be disposed as shown in FIG. 3. That is, one barometer 40 may be disposed inside the supporting member 32, and the other barometer 40 may be disposed at a side of the supporting member 32 adjacent the aircraft body 10. Alternatively, one barometer 40 may be disposed at a part of the connection member 31 of one extension member 30 that is away from the aircraft body 10, and the air port 333 may be provided at a corresponding location; another barometer 40 may be disposed on the supporting member 32 of the other extension member 30 in a manner shown in FIG. 2 or FIG. 3. With this configuration, there is a height difference between the two barometers 40. The height difference between the two barometers and the height values measured by the two barometers 40 may be used to correct the height value of the UAV 100.

The air filter 50 may be similarly received inside the receiving member 33. The air filter 50 may be disposed to surround the barometer 40. Further, the air filter 50 may be disposed between the air port 333 and the barometer 40. The air filter 50 may be a flannel, or an air permeable polyethylene material, such as a sponge, etc. In some embodiments, there may be two air filters 50. The two air filters 50 may be respectively disposed between the barometer 40 and the air port 333 of the first receiving member 331, and between the barometer 40 and the air port 333 of the second receiving member 332. In other embodiments, the air filter 50 may be an integral structure. The air filter 50 may be disposed to wrap around an exterior of the barometer 40. In some embodiments, there may be other number of air filters 50, which is not limited by the present disclosure.

Referring back to FIG. 4, the electronic speed control may be received in the aircraft body 10, and may be electrically connected with the electric motor and the flight controller 70, respectively. The electronic speed control 80 may receive an electrical signal transmitted by the flight controller 70, and may control the operation state of the electric motor based on the control signal transmitted by the flight controller 70, thereby adjusting the operation state of the UAV 100.

The IMU 60 may also be received inside the aircraft body 10. The IMU 60 may be electrically connected with the flight controller 70. The IMU 60 may measure the attitude angles and the accelerations of the three axes of the UAV 100, and may transmit the measured information to the flight controller 70.

The flight controller 70 may be electrically connected with the barometer 40, the electronic speed control 80, and the IMU 60. The flight controller 70 may receive the data information detected by the barometer 40 and the IMU 60, and may analyze the received information and transmit control signals to the electronic speed control 80. The flight controller 70 may control the operation state of the UAV 100 by controlling the operation state of the electronic speed control 80.

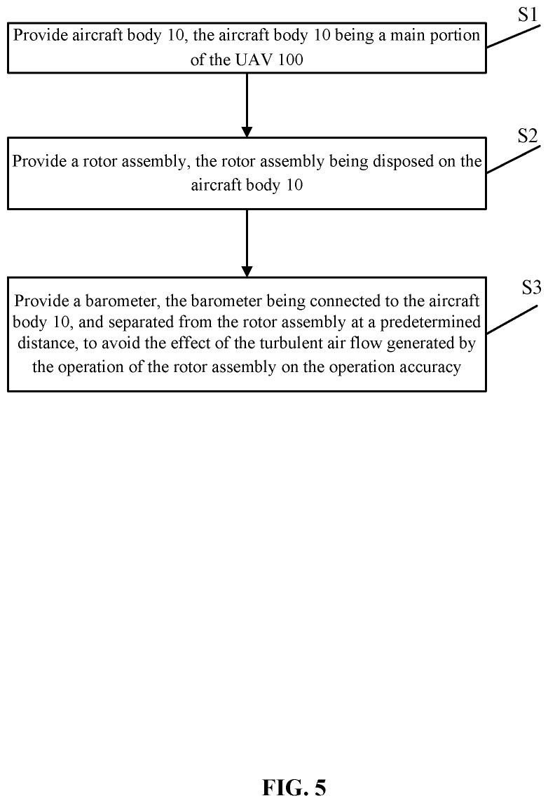

Referring to FIG. 5, the method for assembling the UAV 100 may include the following steps:

S1: providing an aircraft body 10, the aircraft body 10 being a major portion of the UAV 100;

The aircraft body 10 is the major portion of the UAV 100, and is configured to carry the majority of the electronic components of the UAV.

S2: providing a rotor assembly, the rotor assembly being provided on the aircraft body 10;

In the present disclosure, the rotor assembly includes the electric motor and the propeller. When mounting the rotor assembly, first, the electric motor may be mounted to the aircraft body 10, then the propeller may be mounted to the electric motor.

S3: providing a barometer, and connecting the barometer to the aircraft body 10 at a predetermined distance from the rotor assembly, to avoid the effect of the turbulent air flow generated by the operation of the rotor assembly on the operation accuracy of the barometer.

It can be understood that the order of step S2 and step S3 may be exchanged. When the order of the two steps are exchanged, the assembly of the UAV 100 can still be realized, which is not limited by the present disclosure.

Specifically, in some embodiments, the barometer 40 may be mounted inside the extension member 30. It can be understood that the barometer 40 may be disposed at the farthest end of the extension member 30 away from the aircraft body 10. Because the extension member 30 is connected with the aircraft body 10, and extends in a direction away from the rotor assembly, it can be understood that the barometer 40 also extend in a direction away from the rotor assembly. Therefore, it may be determined that the end of the extension member 30 that is farthest away from the aircraft body 10 is separated from the rotor assembly for a predetermined distance. Accordingly, the barometer 40 is also separated from the rotor assembly at a predetermined distance.

In some embodiments, there may be two barometers. The two barometers 40 may be mounted inside two extension members 30, respectively. The two barometers 40 may have the same distance with the rotor assembly, or may have different distances with the rotor assembly. Likewise, the two extension members 30 may have the same distance with the rotor assembly or may have different distances with the rotor assembly. One barometer 40 may be disposed at the extension member 30 at a farthest location from the rotor assembly. It is understood that the barometer 40 may be disposed on, in, partially in, or under the extension member 30. In some embodiments, the barometer 40 may be attached to a side of the extension member 30. Specifically, one barometer 40 may be disposed inside the receiving member 33. The receiving member 33 may be disposed on the extension member 30 at a location farthest from the rotor assembly. Therefore, the barometer mounted inside the receiving member 33 is mounted at a location of the extension member 30 farthest away from the rotor assembly. In some embodiments, the receiving member 33 may be formed at a middle portion of the supporting member 32. The location of the receiving member 33 is the location on the extension member 30 farthest away from the rotor assembly. The extension member 30 may be the landing stand of the UAV 100.

In addition, the UAV 100 may include a flight controller 70. The flight controller 70 and the barometer 40 may be electrically connected. When there are two barometers 40, the flight controller 70 and the two barometers 40 may be electrically connected respectively. The flight controller 70 may calculate the height at which the UAV is located based on the measurement data of the two barometers 40, respectively.

The UAV provided by the present disclosure include the barometer disposed external to the aircraft body, and away from the rotor assembly, thereby reducing the effect of the rotor assembly on the barometer. In addition, the exterior of the barometer is surrounded by the air filter, which further reduces the effect of the air flow on the barometer, thereby effectively enhancing the operation accuracy of the barometer of the UAV.

In addition, a person having ordinary skills in the art can appreciate, that the above embodiments are described to illustrate the technical solutions of the present disclosure, and are not intended to limit the scope of the present disclosure. Within the scope of the spirit of the present disclosure, any suitable change or modification to the embodiments all fall within the scope of protection of the present disclosure.

What is claimed is:

1. An unmanned aerial vehicle (“UAV”), comprising:
an aircraft body;
a rotor assembly mounted on the aircraft body; and
a barometer disposed external to the aircraft body and separated from the rotor assembly at a predetermined distance.

2. The UAV of claim 1, further comprising:
an extension member connected to the aircraft body and extending in a direction facing against the aircraft body,
wherein the barometer is disposed at the extension member.

3. The UAV of claim 2, wherein the extension member is provided with a receiving member configured to receive the barometer therein.

4. The UAV of claim 3, wherein the receiving member is provided with an air port configured to connect an internal chamber of the receiving member with an external environment.

5. The UAV of claim 4, further comprising an air filter disposed inside the receiving member and configured to reduce an impact of an air flow on the barometer when the UAV is in a flight.

6. The UAV of claim 5, wherein the air filter is disposed between the air port and the barometer.

7. The UAV of claim 5, wherein the air filter is disposed to surround the barometer.

8. The UAV of claim 5, wherein the air filter wraps around an exterior of the barometer.

9. The UAV of claim 5, wherein the air filter is made of a flannel.

10. The UAV of claim 5, wherein the air filter is made of a polyethylene material that is air permeable.

11. The UAV of claim 10, wherein the air filter is made of a sponge.

12. The UAV of claim 2,
wherein the extension member is provided at a side of the aircraft body facing against the rotor assembly,
wherein an end of the extension member is connected with the aircraft body, the other end of the extension member extends in a direction away from the rotor assembly, and
wherein the barometer is disposed at the other end of the extension member away from the rotor assembly.

13. The UAV of claim 2, wherein the extension member is a landing stand of the UAV, and wherein the landing stand is configured to provide support to the UAV during landing.

14. The UAV of claim 13, wherein the landing stand is a fixed leg frame structure, and wherein the barometer is received in the landing stand.

15. The UAV of claim 14, wherein the landing stand includes an air port corresponding to the barometer, and wherein the air port is configured to connect an internal chamber of the landing stand and an external environment.

16. The UAV of claim 14, wherein the landing stand includes at least one leg frame, the at least one leg frame includes a connection member, an end of the connection member is disposed on the aircraft body, the other end of the connection member extends in a direction away from the rotor assembly, and wherein the barometer is connected to the connection member.

17. The UAV of claim 16, wherein the leg frame also includes a supporting member disposed at the other end of the connection member that is away from the rotor assembly, and the barometer is received in the supporting member.

18. The UAV of claim 17, wherein the leg frame includes two connection members and one supporting member, each of the two connection members is connected to the aircraft body, and the two connection members are separately disposed at a predetermined distance, and wherein two ends of the supporting member are connected to the two connection members, respectively.

19. The UAV of claim 2, where a quantity of the barometer is one.

20. The UAV of claim 19, wherein the barometer is disposed at a location of the extension member farthest from the rotor assembly.

21. The UAV of claim 2,
wherein the UAV comprises two barometers and a flight controller,
wherein the flight controller is electrically connected with the two barometers respectively, and
wherein the flight controller is configured to calculate a height of the UAV based on measurement data of the two barometers.

22. The UAV of claim 21, wherein distances from the two barometers to the rotor assembly are the same.

23. The UAV of claim 22,
wherein the UAV comprises two extension members, and
wherein the two barometers are disposed on the two extension members, respectively, and wherein each of the two barometers is disposed at a supporting member of each corresponding extension member.

24. The UAV of claim 21, wherein distances from the two barometers to the rotor assembly are different.

25. The UAV of claim 24, wherein a height difference exists between the two barometers.

26. The UAV of claim 25,
wherein the UAV comprises two extension members,
wherein the two barometers and the two extension members are disposed with one-on-one correspondence, and
wherein one of the two barometers is disposed at a supporting member of a corresponding extension member, the other one of the two barometers is disposed at a connection member of a corresponding extension member.

27. The UAV of claim 25,
wherein the UAV comprises two extension members,
wherein the two barometers are disposed at a supporting member of the two extension members, respectively, and
wherein one of the two barometers is disposed at a side of a corresponding supporting member at a side adjacent the aircraft body, the other one of the two barometers is disposed inside a corresponding supporting member.

28. The UAV of claim 24, wherein one of the two barometers is disposed at a location of the extension member farthest from the rotor assembly.

29. The UAV of claim 1, further comprising a landing stand connected to the aircraft body, wherein the barometer is disposed on the landing stand.

30. The UAV of claim 1, further comprising an electronic speed control, wherein the rotor assembly includes an electric motor and a propeller disposed on the electric motor, and wherein the electronic speed control and the electric motor are electrically connected.

31. The UAV of claim 1, further comprising a flight controller and an inertial measurement unit electrically connected with the flight controller,
wherein the inertial measurement unit is configured to detect an attitude of the UAV to enable the flight controller to control a flight of the UAV based on the attitude.
